(19) United States
(12) Patent Application Publication
(10) Pub. No.: US 2009/0255774 A1
(43) Pub. Date: Oct. 15, 2009

(54) RATCHET GEAR DEVICE FOR A BICYCLE REAR WHEEL

(76) Inventor: Chia-Wei HSU, Fusing Hsiang (TW)

Correspondence Address: Hershkovitz & Associates, LLC, 2845 Duke Street, Alexandria, VA, 22314, US

(21) Appl. No.: 12/103,653

(22) Filed: Apr. 15, 2008

(51) Int. Cl. F16D 41/30

(52) U.S. Cl. 192/64

(57) ABSTRACT

A ratchet gear device is applied for a bicycle rear wheel having a wheel axle and a hub mounted on the wheel axle, and the ratchet gear device has a freewheel, a collar, a ratchet ring and at least one permanent magnet. The freewheel is mounted around the wheel axle and has multiple wedging teeth. The collar is magnetic, is mounted securely in the hub and has multiple engaging teeth. The ratchet ring is mounted in the collar and has multiple engaging slots and multiple ratchet teeth. The engaging slots engage the engaging teeth in the collar. The ratchet teeth engage the wedging teeth on the freewheel. The at least one permanent magnet is attached to the ratchet ring to provide a magnetic force to move the ratchet ring to an engaging position where the ratchet teeth engages the wedging teeth on the freewheel.

### BACKGROUND OF THE INVENTION

1. Field of the Invention

The present invention relates to a ratchet gear device, and more particularly to a ratchet gear device for a bicycle rear wheel.

2. Description of Related Art

With reference to FIGS. 4 and 5, a conventional rear wheel for a bicycle has a wheel axle (51), a hub (50) and a ratchet gear device (70). The wheel axle (51) extends through a center of the rear wheel and is connected to a rear fork of the bicycle. The hub (50) is mounted rotatably around the wheel axle (51).

The ratchet gear device (70) is mounted on the wheel axle (51) adjacent to the hub (50) and has a freewheels (60), a collar (71), a ratchet ring (72) and a spring (73). The freewheel (60) is mounted around the wheel axle (51) and has an outer surface, an inner surface, multiple sprockets (61) and multiple wedging teeth (62). The inner surface of the freewheel (60) faces to the hub (50). The sprockets (61) are formed around the outer surface of the freewheel (60) to connect with a chain of the bicycle. The wedging teeth (62) are formed on and protrude from the inner surface of the freewheel (60). The collar (71) is mounted securely in the hub (80). The ratchet ring (72) is mounted around the wheel axle (51), engages the collar (71) and has an inner side, an outer side and multiple ratchet teeth (720). The inner side of the ratchet ring (72) faces to the hub (50) and the outer side faces to the freewheel (60). The ratchet teeth (720) are formed on and protrude from the outer side of the ratchet ring (72) and engage the wedging teeth (62) on the freewheel (60) to allow the collar (71) to rotate with the freewheel (60) in a specific direction but to rotate relative to the freewheel (60) in an opposite direction. The spring (73) is mounted around the wheel axle (51) in the hub (50) and presses against the inner side of the ratchet ring (72).

When the freewheel (60) rotates in counterclockwise relative to hub (50), the wedging teeth (62) on the freewheel (60) will push the ratchet ring (72) to separate the ratchet teeth (720) from the wedging teeth (62)and to compress the spring (73). When the freewheel (60) stops rotating in counterclockwise, the spring (73) will push the ratchet ring (72) to move to engage the ratchet teeth (721) and the wedging teeth (62) on the freewheel (60). Therefore, the elasticity of the spring (73) must be strong enough to push the ratchet ring (72) back, but this will increase the resistance to the freewheel (60) to separate the ratchet teeth (720) of the ratchet ring (72) from the wedging teeth (62).

In addition, the elasticity of the spring (73) may fatigued after a long time of use and cannot push the ratchet ring (72) moving back to a position where the ratchet teeth (720) engages the wedging teeth (62). Thus, the useful life of the ratchet gear device (70) will be shortened by the fatigue of the spring (73).

To overcome the shortcomings, the present invention provides a ratchet gear device to mitigate or obviate the aforementioned problems.

### SUMMARY OF THE INVENTION

The main objective of the present invention is to provide a ratchet gear device for a bicycle rear wheel.

The ratchet gear device in accordance with the present invention for a bicycle rear wheel having a wheel axle and a hub has a freewheel, a collar, a ratchet ring and at least one permanent magnet. The freewheel is mounted around the wheel axle and has multiple wedging teeth. The collar is magnetic, is mounted securely in the hub and has multiple engaging teeth. The ratchet ring is mounted in the collar and has multiple engaging slots and multiple ratchet teeth. The engaging slots engage the engaging teeth in the collar. The ratchet teeth engage the wedging teeth on the freewheel. The at least one permanent magnet is attached to the ratchet ring to provide a magnetic force to push the ratchet ring to an engaging position and make the ratchet teeth engaging the wedging teeth on the freewheel.

Other objectives, advantages and novel features of the invention will become more apparent from the following detailed description when taken in conjunction with the accompanying drawings.

### BRIEF DESCRIPTION OF THE DRAWINGS

FIG. 1 is an exploded perspective view of a ratchet gear device for a bicycle rear wheel in accordance with the present invention;

FIG. 2 is an enlarged side view in partial section of the ratchet gear device in FIG. 1 mounted on a wheel axle of a bicycle rear wheel;

FIG. 3 is an enlarged operational side view in partial section of the ratchet gear device in FIG. 2;

FIG. 4 is a side view in partial section of a ratchet gear device in accordance with the prior art mounted on a wheel axle of a bicycle; and

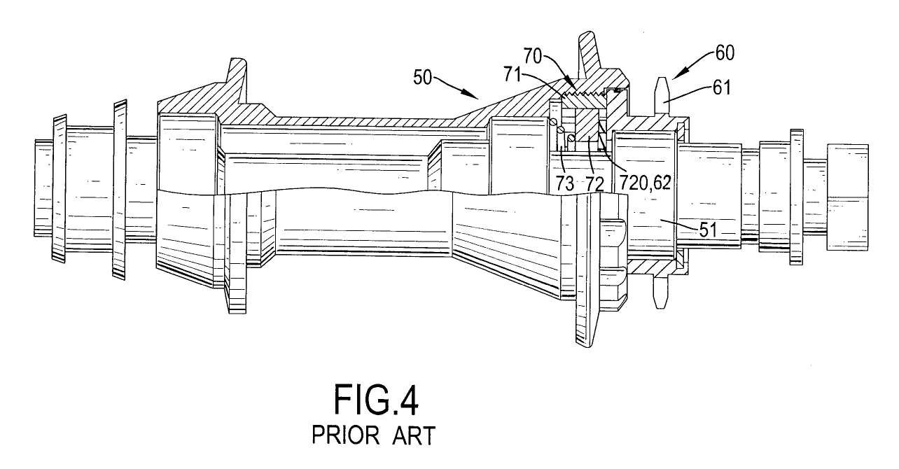

FIG. 5 is an exploded perspective view of the ratchet gear device in FIG. 4.

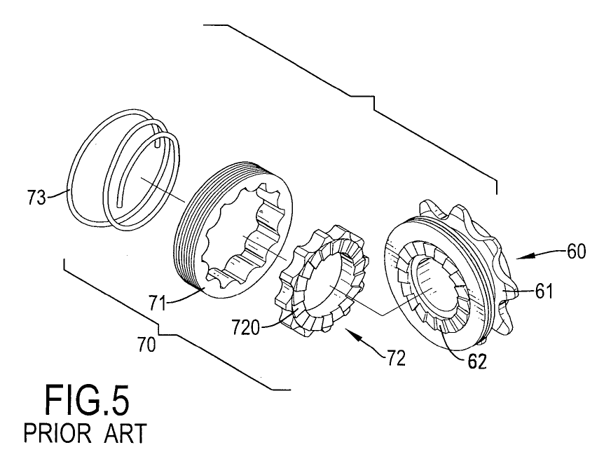

### DETAILED DESCRIPTION OF THE PREFERRED EMBODIMENT

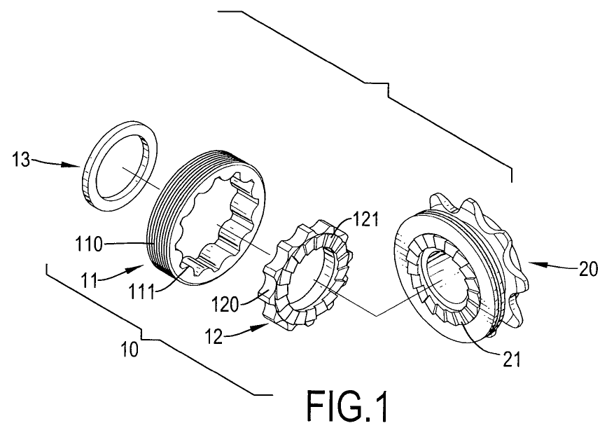

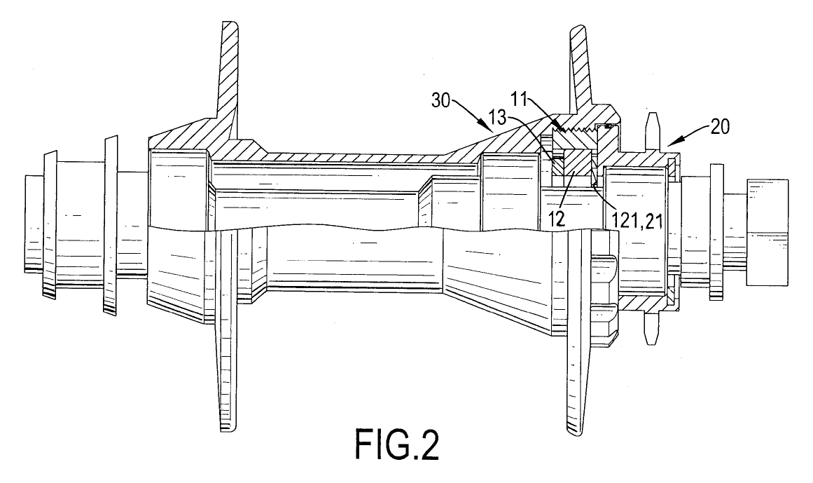

With reference to FIGS. 1 and 2, a ratchet gear device (10) in accordance with the present invention is applied for a bicycle rear wheel having a wheel axle (31) and a hub (30) mounted on the wheel axle (31), and the ratchet gear device (10) has a freewheel (20), a collar (11), a ratchet ring (12) and at least one permanent magnet (13).

The freewheel (20) is mounted around the wheel axle (31) and has an inner surface and multiple wedging teeth (21). The wedging teeth (62) are formed on and protrude from the inner surface of the freewheel (20).

The collar (11) is magnetic, is mounted securely in the hub (30) and has an external surface, an internal surface, a thread (110) and multiple engaging teeth (111). The thread (110) is formed around the external surface of the collar (11) and is screwed with the hub (30). The engaging teeth (111) are formed on and protrude from the internal surface of the collar (11).

The ratchet ring (12) may be magnetic and is mounted on the wheel axle (31), is mounted in the collar (11) and has an inner side, an outer side, an external surface, multiple engaging slots (120) and multiple ratchet teeth (121). The outer side of the ratchet ring (12) faces to the wedging teeth (21) on the freewheel (20). The engaging slots (120) are formed around the external surface of the ratchet ring (12) and engage the engaging teeth (111) in the collar (11). The ratchet teeth (121) are formed on and protrude from the outer side of the ratchet ring (12) and engage the wedging teeth (21) on the freewheel (20) to allow the ratchet ring (12) to rotate with freewheel (20) in a specific direction, for example in clockwise, but relative to the freewheel (20) in an opposite direction, for example in counterclockwise.

The at least one permanent magnet (13) may be arranged in annular, is mounted around the wheel axle (31) in the collar (11) and is attached to the inner side of the ratchet ring (12) to make the ratchet teeth (121) engaging the wedging teeth (21) on the freewheel (20). In an embodiment, the ratchet gear device (10) has a single annular permanent magnet (13). In an alternative embodiment, the ratchet gear device (10) has multiple permanent magnets (13) attached to the inner side of the ratchet ring (12) and arranged in annular at even intervals.

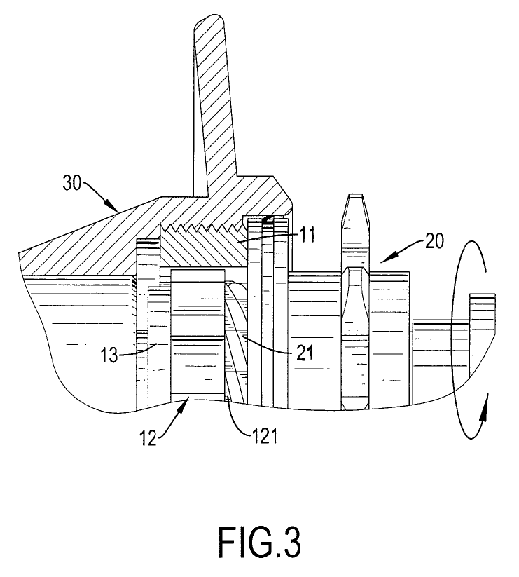

With further reference to FIG. 3, when the freewheel (20) rotates in counterclockwise relative to hub (30), and the wedging teeth (21) on the freewheel (20) will push the ratchet teeth (121) to separate from and the wedging teeth (21) and push the ratchet ring (12) moving inward along the wheel axle (31). With the movement of the ratchet ring (12), the at least one permanent magnet (13) is moved out of the collar (11). When the freewheel (20) stops rotating, the collar (11) provides a magnetic attracting force to the at least one permanent magnet (13) to move the at least one magnet (13) into the collar (11). Consequently, the ratchet ring (12) is moved back to a position where the ratchet teeth (121) engage the wedging teeth (21) on the freewheel (20).

The magnetic force of the at least one permanent magnet (13) can push the ratchet ring (12) back to the engaging location easily, and doesn't increase the resistance to the freewheel (20) to separate the ratchet teeth (121) of the ratchet ring (12) from the wedging teeth (21). Furthermore, the magnetic force of the at least one permanent magnet (13) will not disappear even after a long time of use, so the useful life of the ratchet gear device (70) is longer than a conventional one with a spring (73).

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A ratchet gear device for a bicycle rear frame having a wheel axle and a hub being mounted on the wheel axle, and the ratchet gear device having
a freewheel being adapted to mount around the wheel axle and having an inner surface; and
multiple wedging teeth being formed on and protruding from the inner surface of the freewheel;
a collar being magnetic, being adapted to mount securely in the hub and having
an external surface;
an internal surface;
a thread being formed around the external surface of the collar to screw with the hub; and
multiple engaging teeth being formed on and protruding from the internal surface of the collar;
a ratchet ring being adapted to mount on the wheel axle, being mounted in the collar and having
an inner side;
an outer side facing to the wedging teeth on the freewheel;
an external surface;
multiple engaging slots being formed around the external surface of the ratchet ring and engaging the engaging teeth in the collar; and
multiple ratchet teeth being formed on and protruding from the outer side of the ratchet ring and engaging the wedging teeth on the freewheel to make the ratchet ring rotating with the ratchet ring in a specific direction; and
at least one permanent magnet being attached to the inner side of the ratchet ring.

2. The ratchet gear device as claimed in claim 1, wherein the ratchet gear device has a single annular permanent magnet.
